(19) United States
(12) Patent Application Publication
(10) Pub. No.: US 2008/0272117 A1
(43) Pub. Date: Nov. 6, 2008

(54) FOLDABLE MULTIPURPOSE CONTAINER

(76) Inventors: Diane P. Roos, Locust Grove, VA (US); George H. Kelly, Locust Grove, VA (US)

Correspondence Address: CHRISTOPHER PAUL MITCHELL, 888 16TH ST., NW, SUITE 800, WASHINGTON, DC, 20006, US

(21) Appl. No.: 12/113,144

(22) Filed: Apr. 30, 2008

Related U.S. Application Data
(60) Provisional application No. 60/924,113, filed on May 1, 2007.

(51) Int. Cl. B65D 6/18; B23P 11/00

(52) U.S. Cl. 220/6; 29/592

(57) ABSTRACT

A foldable multipurpose container. The foldable multipurpose container may include a plurality of wall components, including a top; and a plurality of unfolded container shape retention rod assemblies. At least one of the plurality of wall components may be formed of a soft sheet material. At least one of the unfolded container shape retention rod assemblies may be bendable and resilient. The foldable multipurpose container may be capable of an unfolded state and a folded state.

### CROSS-REFERENCE TO RELATED APPLICATIONS

This application claims the benefit of Provisional Application Ser. No. 60/924,113, filed May 1, 2007, which is herein incorporated by reference in its entirety.

### BACKGROUND

1. Field

Embodiments of the present invention relate generally to multipurpose containers and, more particularly, to foldable multipurpose containers.

2. Description of the Related Art

Containers have been a part of human society for at least thousands of years. Contemporary multipurpose containers may be used, for example, as storage or refuse collection units, or as coolers.

General purpose containers may have disadvantages, including, excessive weight, fixed shape, cumbersome installation and removal, and lack of compactness when removed for storage.

### BRIEF SUMMARY

According to an aspect of the invention, a foldable multipurpose container may be provided. The foldable multipurpose container may include a plurality of wall components, including a top; and a plurality of unfolded container shape retention rod assemblies. At least one of the plurality of wall components may be formed of a soft sheet material. At least one of the unfolded container shape retention rod assemblies may be bendable and resilient. The foldable multipurpose container may be capable of an unfolded state and a folded state.

According to another aspect of the invention, a foldable multipurpose container may be provided. The foldable multipurpose container may include a plurality of soft sheet material wall components, including a top, and at least two of the soft sheet material wall components including a channel along an edge; and a plurality of bendable and resilient metal unfolded container shape retention rod assemblies, at least two of which being at least partially housed within the channels. The foldable multipurpose container may be capable of an unfolded state and a folded state.

According to another aspect of the invention, a method of manufacture may be provided. The method of manufacture may include providing a plurality of wall components, including a top; and providing a plurality of unfolded container shape retention rod assemblies. At least one of the plurality of wall components may be formed of a soft sheet material. At least one of the unfolded container shape retention rod assemblies may be bendable and resilient. The foldable multipurpose container may be capable of an unfolded state and a folded state.

The foregoing and other aspects will become apparent from the following detailed description when considered in conjunction with the accompanying drawing figures.

### BRIEF DESCRIPTION OF THE DRAWINGS

FIG. 1 is a side perspective view of a foldable multipurpose container according to an embodiment of the present invention.

FIG. 2 is a rear perspective view of the foldable multipurpose container of FIG. 1.

FIG. 3 is a top elevational view of the foldable multipurpose container of FIG. 1.

FIG. 4 is a bottom elevational view of the foldable multipurpose container of FIG. 1.

FIG. 5 is a bottom perspective view of the foldable multipurpose container of FIG. 1.

FIG. 6 is a side perspective view of the foldable multipurpose container of FIG. 1 in a folded state.

FIG. 7 is a side perspective view of unfolded container shape retention rod assemblies of the foldable multipurpose container of FIG. 1.

FIG. 8 is a top elevational view of the unfolded container shape retention rod assemblies of FIG. 7.

FIG. 9 is a top elevational view of the foldable multipurpose container of FIG. 1 in an unassembled state not including unfolded container shape retention rod assemblies.

FIG. 10 is a side perspective view of a foldable multipurpose container according to an embodiment of the present invention.

FIG. 11 is a rear perspective view of the foldable multipurpose container of FIG. 10.

FIG. 12 is a side perspective view of the foldable multipurpose container of FIG. 10 in a folded state.

FIG. 13 is a top elevational view of the foldable multipurpose container of FIG. 10 in an unassembled state not including unfolded container shape retention rod assemblies.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

As used herein, the terms “a”, “an” and “the” may refer to one or more than one of an item. The terms “and” and “or” may be used in the conjunctive or disjunctive and will generally be understood to be equivalent to “and/or”. For brevity and clarity, a particular quantity of an item may be described or shown while the actual quantity of the item may differ.

In accordance with an embodiment of the present invention, a foldable multipurpose container may be provided. The foldable multipurpose container may permit both ease of folding to an essentially flat shape and compact size, and ease of unfolding. The foldable multipurpose container may be for multiple purposes, including not by way of limitation, camping, boating, and motor vehicle applications, as storage or refuse collection units, or as a cooler. When unfolded, a foldable multipurpose container may either stand alone or employ a mounting strap such as a hook and loop strap or fasteners to affix the foldable multipurpose container around or onto various object surfaces, including not by way of limitation, the door of a vehicle glove compartment, a vehicle seat back, a tree, a boat surface (e.g., a boat wall, console, frame, gate, or seat), or a deck surface (e.g., residential deck railing). The foldable multipurpose container may include a plurality of wall components, including a top; and a plurality of unfolded container shape retention rod assemblies, wherein at least one of the plurality of wall components is formed of a soft sheet material, wherein at least one of the unfolded container shape retention rod assemblies is bendable and resilient, and wherein the foldable multipurpose container is capable of an unfolded state and a folded state.

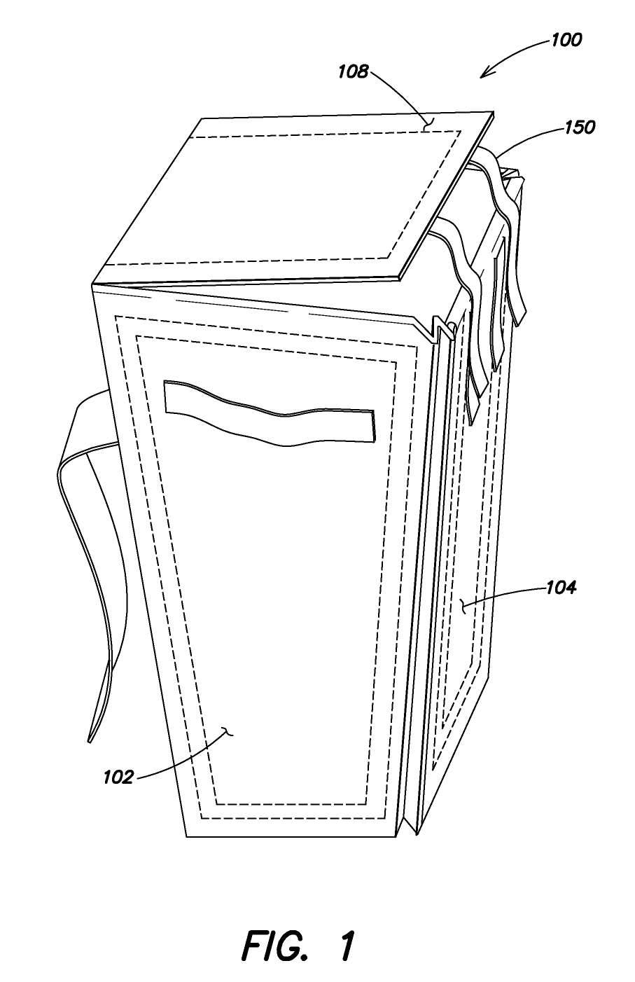

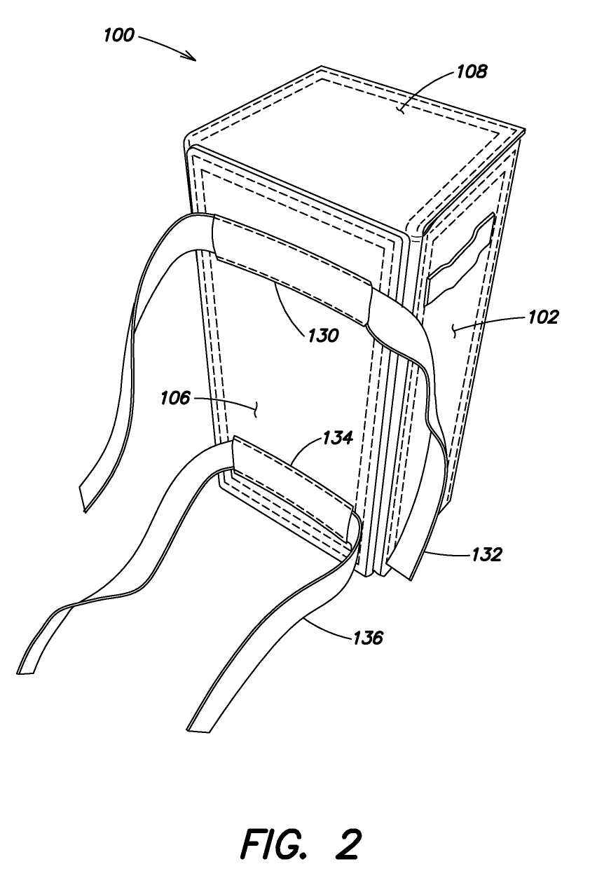

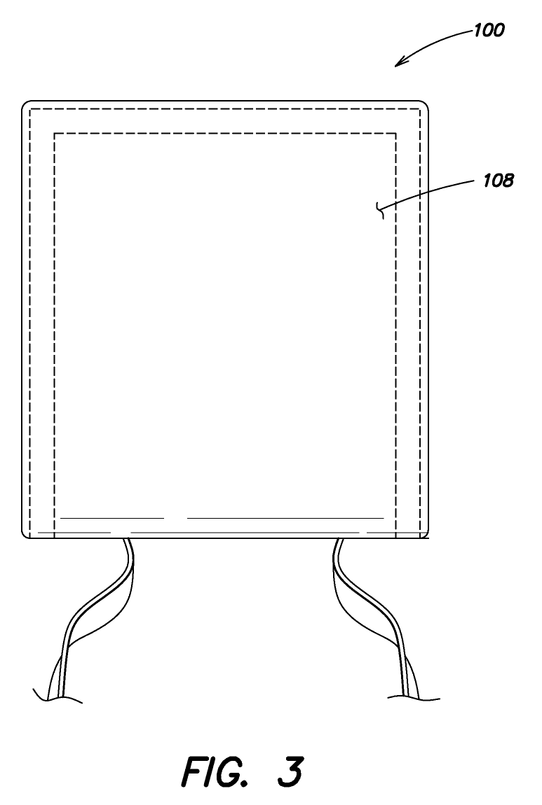

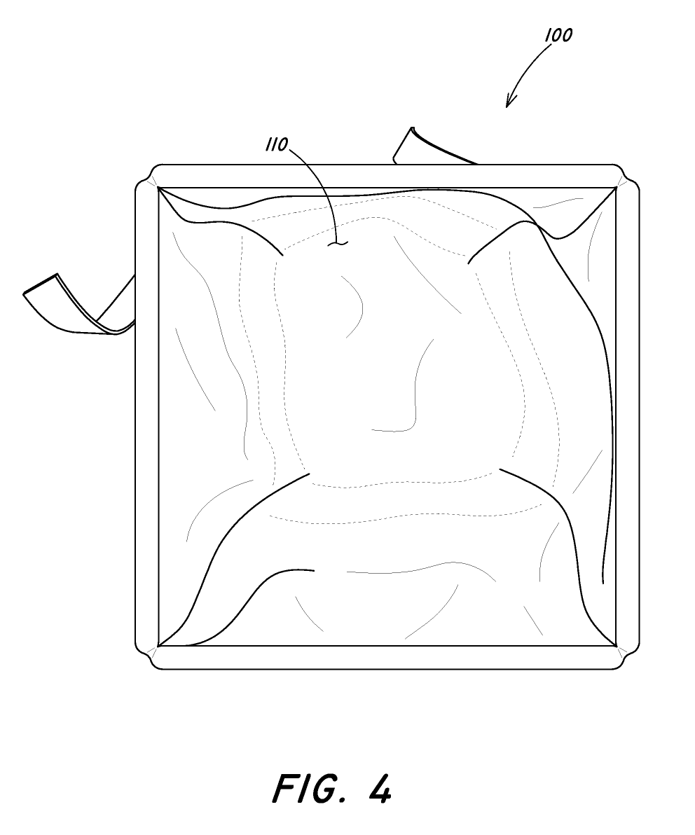

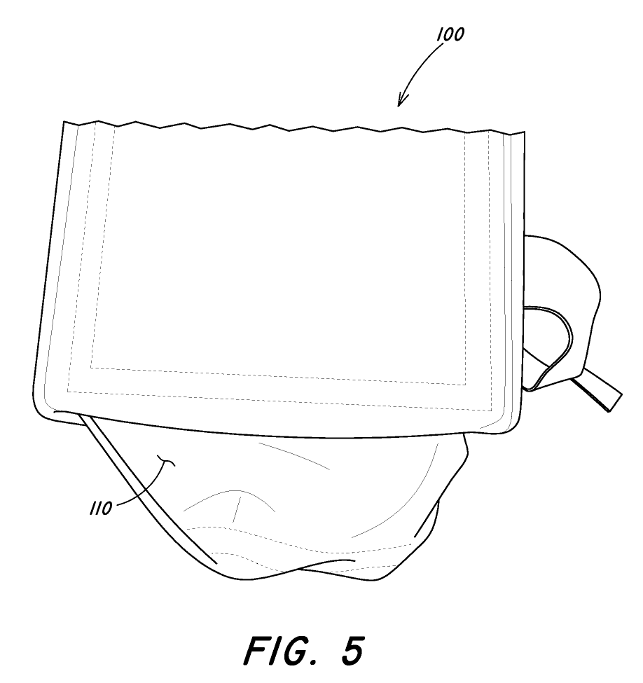

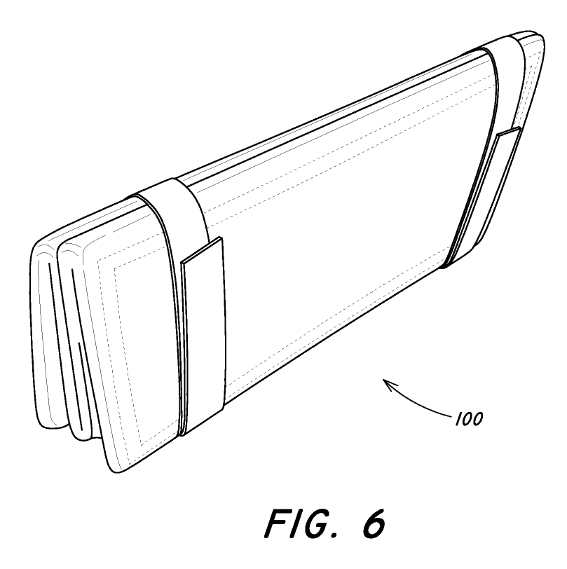

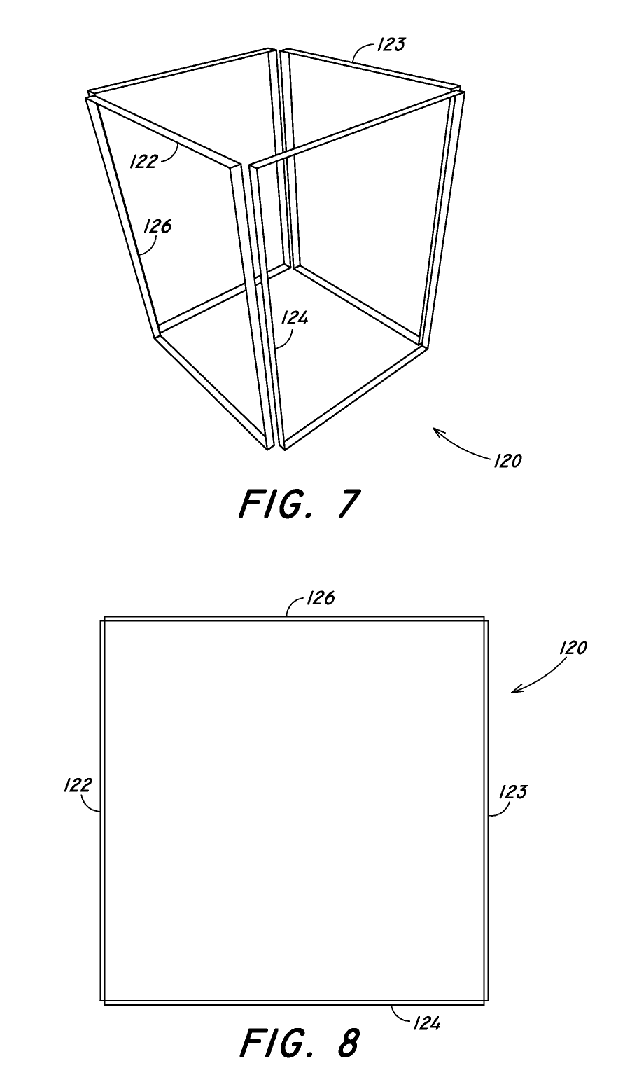

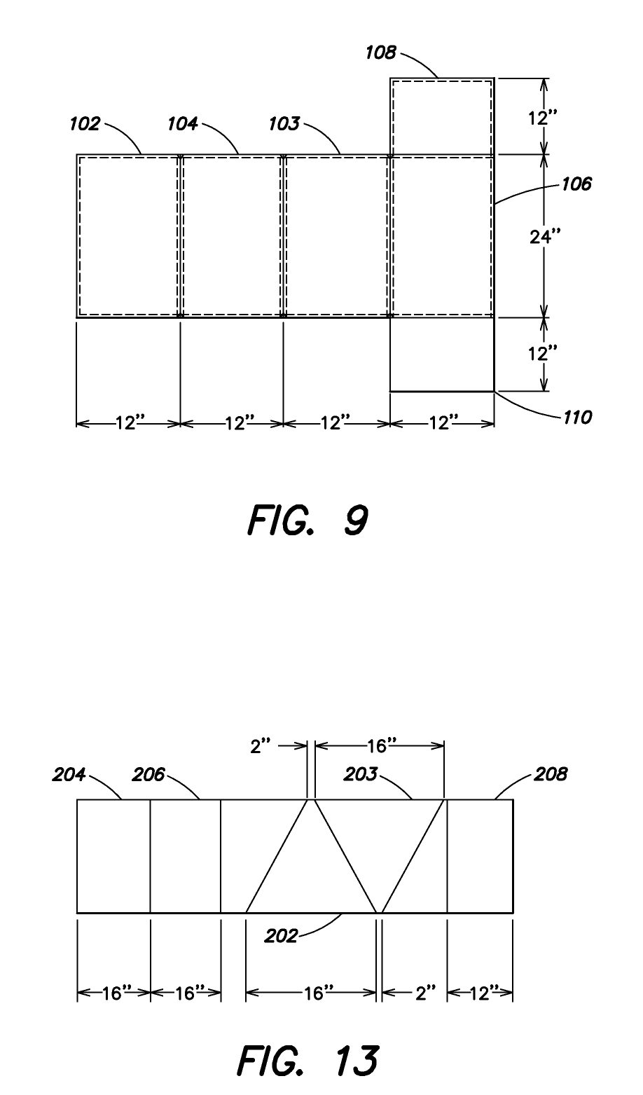

FIG. 1 is a side perspective view of a foldable multipurpose container 100 according to an embodiment of the present invention. FIG. 2 is a rear perspective view of the foldable multipurpose container 100 of FIG. 1. FIG. 3 is a top elevational view of the foldable multipurpose container 100 of FIG. 1. FIG. 4 is a bottom elevational view of the foldable multipurpose container 100 of FIG. 1. FIG. 5 is a bottom perspective view of the foldable multipurpose container of FIG. 1. FIG. 6 is a side perspective view of the foldable multipurpose container 100 of FIG. 1 in a folded state. FIG. 7 is a side perspective view of unfolded container shape retention rod assemblies 122, 123, 124, and 126 (collectively 120) of the foldable multipurpose container 100 of FIG. 1. FIG. 8 is a top elevational view of the unfolded container shape retention rod assemblies 120 of FIG. 7. FIG. 9 is a top elevational view of the foldable multipurpose container 100 of FIG. 1 in an unassembled state not including unfolded container shape retention rod assemblies 120.

Turning to FIG. 1, the foldable multipurpose container 100 may include a first side 102, a second side 103 (see FIG. 9), a front 104, a back 106 (see FIG. 2), a top 108, and a bottom 110 (see FIG. 4), one or more of which may include a soft sheet material. The foldable multipurpose container 100 may further include unfolded container shape retention rod assemblies 120 (see FIG. 3), first and second sleeves 130, 134, first and second mounting straps 132, 136, and fasteners 150.

In an unfolded state, the foldable multipurpose container 100 may be rectangular in shape. In alternative embodiments, the foldable multipurpose container 100 may be any of a variety of shapes. By way of non-limiting example, the foldable multipurpose container may be triangular. Turning back to the present embodiment, the back 106 may be attached to the top 108, the bottom 110 and the first and second sides 102, 103. The first and second sides 102, 103 may be connected to the front 104, thereby forming a rectangular shape when in the unfolded state.

As noted above, one or more of the first side 102, second side 103, front 104, back 106, top 108, and bottom 110 may include a soft sheet material. By way of non-limiting example, the soft sheet material may include a canvas material. Alternatively or additionally, the soft sheet material may include an insulation layer such as, by way of non-limiting example, urethane insulation with a condensation barrier.

As noted above, the back 106, various wall components (e.g., the top 108, bottom 110, first and second sides 102, 103, and the front 104) may be connected. These wall components may be formed of the same piece of soft sheet material. Alternatively or additionally, the wall components may be connected via appropriate fastening, including by way of non-limiting example, stitching.

One or more of the first side 102, second side 103, front 104, back 106, top 108, and bottom 110 may include a channel along an edge. A channel may be formed by stitching hook and loop strips to the sheet material so that the sheet material may be fastened to itself to form the channel. Alternatively or additionally, fasteners may be used to create either a channel or other fastener to secure the unfolded container shape retention rod assemblies 120 and the sheet material. These channels may house the unfolded container shape retention rod assemblies 120. By way of non-limiting example, each of the first side 102, second side 103, front 104 and back 106 may include channels along each edge. That is, the first side 102 may include a channel at each of its four edges, the second side 103 may include a channel at each of its four edges, and so on in like manner for the front 104 and back 106. The top 108 may include channels along three edges. The first side 102 channels may house a first side unfolded container shape retention rod assembly 122, the second side 103 channels may house a second side unfolded container shape retention rod assembly 123, and so on in like manner for the front 104 channels and back 106 channels, and also for the three channels on the top. The unfolded container shape retention rod assemblies 120 may be formed in a rectangular shape. The unfolded container shape retention rod assemblies 120 may be formed of a resilient material. By way of non-limiting example, the unfolded container shape retention rod assemblies 120 may be formed of resilient metal flat wire (e.g., resilient steel flat wire). The resilient metal flat wire may have smoothed edges to prevent wear on the sheet material.

The bottom 110 may be selectively detachable via, by way of non-limiting example, a zipper along the edges of the bottom and the first and second sides 102, 103, the front 104, and back 106. Turning to FIG. 5, the bottom 110 may be trapezoidal in shape so as to allow flexibility when the foldable multipurpose container 100 is folded into a collapsed state.

The foldable multipurpose container 100 may be formed in any of a variety of sizes. By way of non-limiting examples, the foldable multipurpose container 100 may be 24 inches tall by 12 inches deep by 12 inches wide, and may have a storage volume capacity of approximately two cubic feet, or 36 by 20 by 20 with a storage volume capacity of approximately 8.4 cubic feet.

Turning to FIG. 6, the foldable multipurpose container 100 may be folded into a collapsed state for easy maneuverability and storage. The foldable multipurpose container 100 when in the collapsed state may be essentially flat. By way of non-limiting example, the foldable multipurpose container 100 may be one and one-half inches thick.

When returned to the unfolded state, the foldable multipurpose container 100 may be used for multiple purposes, including not by way of limitation, camping, boating, and motor vehicle applications, as a storage or refuse collection unit, or as a cooler. When unfolded, the foldable multipurpose container 100 may either stand alone or employ first and second mounting straps 132, 134 to affix the foldable multipurpose container 100 around or onto various object surfaces, including not by way of limitation, a tree, a boat surface (e.g., a boat wall, console, frame, gate, or seat), or a deck surface (e.g., residential deck railing). The mounting straps 132, 134 may include hook and loop straps and may be run through first and second sleeves 130, 132. The foldable multipurpose container 100 may include fasteners 150 to fasten the top 108 to the front 104. The fasteners 150 may include hook and loop straps.

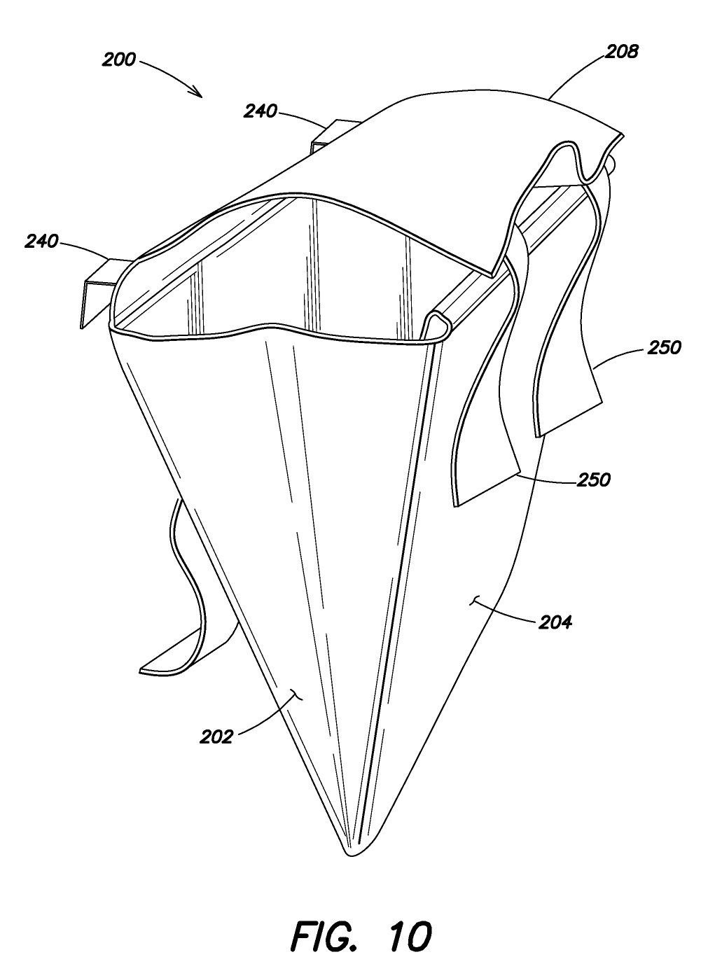

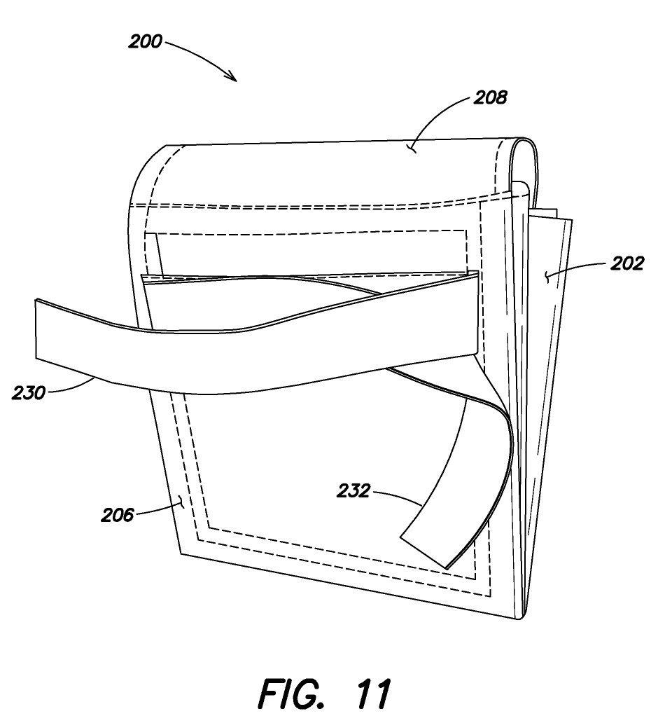

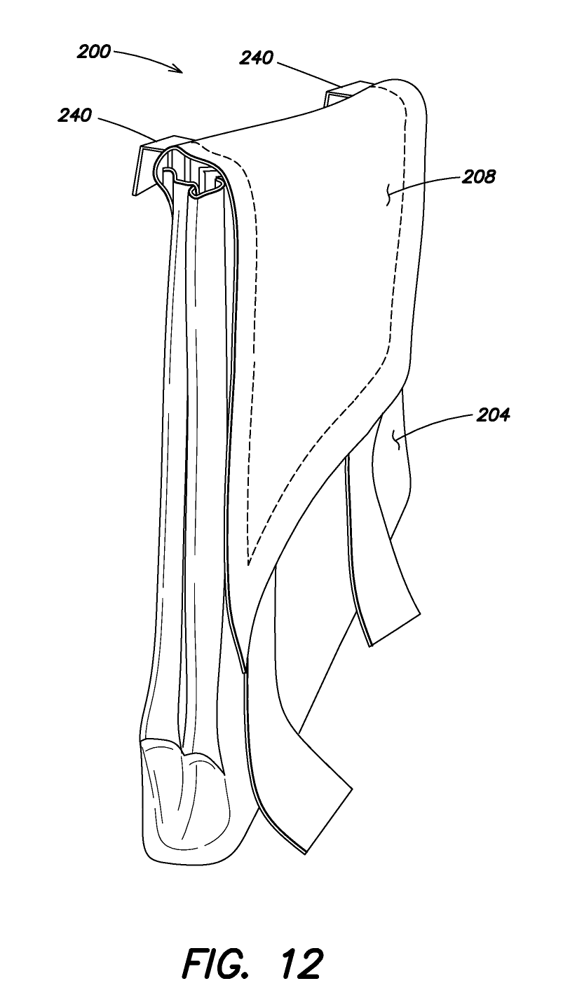

FIG. 10 is a side perspective view of a foldable multipurpose container 200 according to an embodiment of the present invention. FIG. 11 is a rear perspective view of the foldable multipurpose container 200 of FIG. 10. FIG. 12 is a side perspective view of the foldable multipurpose container 200 of FIG. 10 in a folded state. FIG. 13 is a top elevational view of the foldable multipurpose container 200 of FIG. 10 in an unassembled state not including unfolded container shape retention rod assemblies. Many aspects and additions of the foldable multipurpose container 200 may be similar to aspects and additions of the foldable multipurpose container 100, and are, for brevity and clarity, not repeated.

The foldable multipurpose container 200 may include a first side 202, a second side 203 (FIG. 13), a front 204, a back 206 (FIG. 11), a top 208, and a bottom 210, one or more of which may include a soft sheet material. The foldable multipurpose container 200 may further include unfolded container shape retention rod assemblies, a sleeve 230, a mounting strap 232, brackets 240, and fasteners 250.

In an unfolded state, the foldable multipurpose container 200 may be triangular in shape. In alternative embodiments, the foldable multipurpose container 200 may be any of a variety of shapes. By way of non-limiting example, the foldable multipurpose container may be square. Turning back to the present embodiment, the back 206 may be connected to the top 208, the bottom 210, the first and second sides 202, 203, and the front 204, thereby forming a triangular or generally “V” shape when in the unfolded state.

The soft sheet material may include a canvas material. Various wall components (e.g., the top 208, bottom 210, first and second sides 202, 203, and the front 204) may be connected. These wall components may be formed of the same piece of soft sheet material. Alternatively or additionally, the wall components may be connected via appropriate fastening, including by way of non-limiting example, stitching.

One or more of the first side 202, second side 203, front 204, back 206, top, and bottom 210 may include a channel along an edge. By way of non-limiting example, each of the front 204 and back 206 may include channels along each edge. That is, the front 204 may include a channel at each of its four edges and the back 206 may include a channel at each of its four edges. The front 204 channels may house a front unfolded container shape retention rod assembly and the back 206 may house a back unfolded container shape retention rod assembly. The unfolded container shape retention rod assemblies may form a “V” shape. The unfolded container shape retention rod assemblies may be formed of a resilient material.

The foldable multipurpose container 200 may be formed in any of a variety of sizes. By way of non-limiting example, the foldable multipurpose container 200 may be 8 inches deep on top and 2 inches deep on the bottom, 12 inches wide, and 12 inches tall.

Turning to FIG. 12, the foldable multipurpose container 200 may be folded into a collapsed state for easy maneuverability and storage. The foldable multipurpose container 200 when in the collapsed state may be essentially flat. By way of non-limiting example, the foldable multipurpose container 200 may be one- and one-half inches thick.

When returned to the unfolded state, the foldable multipurpose container 200 may be used for multiple purposes, including not by way of limitation, motor vehicle applications, as a storage or refuse collection unit. The mounting strap 232 may be used to affix the foldable multipurpose container 200 to the door of a vehicle glove compartment or a vehicle seat back. The mounting strap 232 may include a hook and loop strap and may be run through the sleeve 230. Alternatively or additionally, the foldable multipurpose container 200 may include brackets 240 to affix the foldable multipurpose container 200 to various object surfaces, including not by way of limitation, the door of a vehicle glove compartment or a vehicle seat back. The foldable multipurpose container 100 may include fasteners 250 to fasten the top 208 to the front 204. The fasteners 150 may include hook and loop straps.

FIGS. 7-9 and 13 may additionally show a method of manufacturing a foldable multipurpose container. Specifically, in FIGS. 9 and 13, a plurality of wall components may be provided. In FIGS. 7 and 8, a plurality of unfolded container shape retention rod assemblies may be provided.

Although embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A foldable multipurpose container, comprising:
a plurality of wall components, including a top; and
a plurality of unfolded container shape retention rod assemblies,
wherein at least one of the plurality of wall components is formed of a soft sheet material,
wherein at least one of the unfolded container shape retention rod assemblies is bendable and resilient, and
wherein the foldable multipurpose container is capable of an unfolded state and a folded state.

2. The foldable multipurpose container of claim 1, wherein the at least one wall component formed of a soft sheet material comprises a channel along an edge to house the at least one unfolded container shape retention rod assembly that is bendable and resilient.

3. The foldable multipurpose container of claim 2, wherein the channel comprises a hook and loop strip closure.

4. The foldable multipurpose container of claim 1, wherein the plurality of wall components comprise:
a first side;
a second side;
a front connected to the first side and the second side;
a back connected to the first side, the second side, and the top; and
a bottom selectively connected to the first side, the second side and the front,
wherein the first side, second side, front, back, top, and bottom define a rectangular shape when the foldable multipurpose container is in the unfolded state.

5. The foldable multipurpose container of claim 4, wherein the bottom is selectively connected to the first side, the second side, and the front via a zipper.

6. The foldable multipurpose container of claim 4, wherein the bottom defines a trapezoidal shape.

7. The foldable multipurpose container of claim 4, wherein the back comprises a sleeve to receive a mounting strap to secure the foldable multipurpose container to an external object.

8. The foldable multipurpose container of claim 4, wherein the top comprises a fastener to secure the top to at least one of the first side, second side, back, or front.

9. The foldable multipurpose container of claim 1, wherein the plurality of wall components comprise:
a first side;
a second side;
a front connected to the first side and the second side; and
a back connected to the first side, the second side, and the top,
wherein the first side, second side, front, back, top, and bottom define a triangular shape when the foldable multipurpose container is in the unfolded state.

10. The foldable multipurpose container of claim 9, further comprising a bottom connected to the front and back.

11. The foldable multipurpose container of claim 9, wherein the back comprises a sleeve to receive a mounting strap to secure the foldable multipurpose container to an external object.

12. The foldable multipurpose container of claim 9, wherein the back comprises a bracket to secure the foldable multipurpose container to an external object.

13. The foldable multipurpose container of claim 9, wherein the top comprises a fastener to secure the top to at least one of the first side, second side back, or front.

14. A foldable multipurpose container, comprising:
a plurality of soft sheet material wall components, including a top, and at least two of the soft sheet material wall components including a channel along an edge; and
a plurality of bendable and resilient metal unfolded container shape retention rod assemblies, at least two of which being at least partially housed within the channels,
wherein the foldable multipurpose container is capable of an unfolded state and a folded state.

15. The foldable multipurpose container of claim 14, wherein the first side, second side, front, back, top, and bottom define either a rectangular or triangular shape when the foldable multipurpose container is in the unfolded state.

16. A method of manufacturing a foldable multipurpose container, comprising:
providing a plurality of wall components, including a top; and
providing a plurality of unfolded container shape retention rod assemblies,
wherein at least one of the plurality of wall components is formed of a soft sheet material,
wherein at least one of the unfolded container shape retention rod assemblies is bendable and resilient, and
wherein the foldable multipurpose container is capable of an unfolded state and a folded state.

17. The method of manufacturing a foldable multipurpose container of claim 16, wherein the at least one wall component formed of a soft sheet material comprises a channel along an edge to house the at least one unfolded container shape retention rod assembly that is bendable and resilient.

18. The method of manufacturing a foldable multipurpose container of claim 17, wherein the channel comprises a hook and loop strip closure.

19. The method of manufacturing a foldable multipurpose container of claim 16, wherein the plurality of wall components comprise:
a first side;
a second side;
a front connected to the first side and the second side;
a back connected to the first side, the second side, and the top; and
a bottom selectively connected to the first side, the second side and the front,
wherein the first side, second side, front, back, top, and bottom define a rectangular shape when the foldable multipurpose container is in the unfolded state.

20. The method of manufacturing a foldable multipurpose container of claim 16, wherein the plurality of wall components comprise:
a first side;
a second side;
a front connected to the first side and the second side;
a back connected to the first side, the second side, and the top; and
a top connected to the back,
wherein the first side, second side, front, back, top, and bottom define a triangular shape when the foldable multipurpose container is in the unfolded state.
